(19) United States
(12) Patent Application Publication
(10) Pub. No.: US 2023/0048304 A1
(43) Pub. Date: Feb. 16, 2023

(54) ENVIRONMENTALLY AWARE PREDICTION OF HUMAN BEHAVIORS

(71) Applicant: Humanising Autonomy Limited, London (GB)

(72) Inventors: Leslie Cees Nooteboom, London (GB); Raunaq Bose, London (GB); Maya Audrey Lara Pindeus, London (GB); Dominic Noy, London (GB); James Over Everard, Manningtree (GB); Yazhini Chitra Pradeep, London (GB)

(21) Appl. No.: 17/402,418

(22) Filed: Aug. 13, 2021

(51) Int. Cl. B60W 40/04; G06N 20/00; B60W 50/06; G08G 1/01

(52) U.S. Cl. CPC B60W 40/04; G06N 20/00; B60W 50/06; G08G 1/0125; B60W 2420/42; B60W 2554/40; B60W 2552/00

(57) ABSTRACT

A behavior prediction system predicts human behaviors based on environment-aware information such as camera movement data and geospatial data. The system receives sensor data of a vehicle reflecting a state of the vehicle at a given time and a given location. The system determines a field of concern in images of a video stream and determines one or more portions of images of the video stream that correspond to the field of concern. The system may apply different levels of processing powers to objects in the images based on whether an object is in the field of concern. The system then generates features of objects and identify VRUs from the objects of the video stream. For the identified VRUs, the system inputs a representation of the VRUs and the features into a machine learning model, and outputs from the machine learning model a behavioral risk assessment of the VRUs.

### BACKGROUND

Related art systems have attempted to predict pedestrian behaviors based on a sequence of images from a video stream captured by a camera coupled with a vehicle. However, people behave differently in different environments and situations. For example, the different behaviors may be observed in different countries, different cites, or even in different regions within the same city. Therefore, a behavior prediction system that does not account for environment-specific information in understanding and predicting human behaviors may be problematic when the model is scaling to new environments.

Processing and analyzing video streams comprising analyzing a large number of high-resolution images in a video stream and requires intensive computing power to process the pixels in each image. Existing systems often need to resize images prior to processing because the number of pixels that can be analyzed by a model within a limited time is often limited. Resizing images changes (e.g. compresses) pixel information which often leads to information loss of the whole image. As a result, processing power wasted on pixels of areas of images that are not significant for analysis be more efficiently utilized on portions of the images that are associated with more interesting features.

### SUMMARY

Systems and methods are disclosed herein for a behavior prediction system for predicting human behaviors based on environment-aware information such as camera movement data and geospatial data. The behavior prediction system receives a set of sensor data of a vehicle reflecting a state of the vehicle at a given time and a given location. Based on the set of received sensor data, the behavior prediction system determines a field of concern in images of a video stream. Based on the determined field of concern, the behavior prediction system may determine one or more portions of images of the video stream that correspond to the field of concern. The behavior prediction system may apply different levels of processing powers to objects in the images based on whether an object is in the field of concern. The system then generates features of objects and identify one or more vulnerable road users (VRUs) from the objects of the video stream. For the identified VRUs, the system inputs a representation of the VRUs and the features into a machine learning model, and outputs from the machine learning model a behavioral risk assessment of the VRUs.

The behavioral prediction model may make predictions based on a set of sensor data as well as based on analysis of images from a video stream captured from a camera coupled to a machine (e.g. vehicle). The set of sensor data may provide context-specific information related to camera-movement and geospatial information besides the video stream as input to the model for understanding the environment around the vehicle. For example, camera sensor data may include acceleration, yaw, ego-movement, and depth estimation. Geospatial data may include behavior information related to a given location, such as behavior models for different countries, different cities, different regions of a city, cultural difference, different legislative requirements for different environments, etc. The camera movement data and geospatial data further enrich the behavior prediction system for an environment-aware prediction of human behaviors.

The disclosed systems and methods provide several advantageous technical features. For example, the disclosed behavior prediction system uses extrinsic information collected from additional sensors to improve predictions accuracy of human behaviors. Using contextual information as an additional input into the behavior prediction model enables the prediction model to be more adaptable for predicting human behaviors when scaling to new environments. The behavior prediction system may adapt different prediction models to different countries, cities, types of areas. etc. Furthermore, the behavior prediction system determines a field of concern in the sequence of images to analyze and focuses more processing power on the field of concern.

The disclosed behavior prediction system improves efficiency and accuracy of behavior prediction by identifying a field of concern in a video stream. Focusing processing power on a field concern may save processing power and improve prediction accuracy. Current systems often need to resize images prior to processing because the number of pixels that can be analyzed by a model is often limited. Resizing images changes (e.g. compresses) pixel information which often leads to information loss. In the system disclosed, the field of concern may be the focus of analysis and the portions of images for the field of concern may not need to be resized, and as a result, more pixels for the determined field of concern are available for analysis. With more information to analyze and to use as input to the prediction system, the disclosed behavior prediction system may provide an environment aware and processing power efficient prediction of human behaviors that is adaptable to new environments.

### BRIEF DESCRIPTION OF THE DRAWINGS

FIG. 1 depicts an exemplary system environment for a behavior prediction system, in accordance with one embodiment.

FIG. 2 depicts exemplary modules of a behavior prediction system, in accordance with one embodiment.

FIG. 3 depicts an exemplary modules of a motion data analysis module of the behavior prediction system, in accordance with one embodiment.

FIG. 4 depicts an exemplary modules of a geospatial data analysis module of the behavior prediction system, in accordance with one embodiment.

FIG. 5 depicts an exemplary modules of a field of concern analysis module of the behavior prediction system, in accordance with one embodiment.

FIG. 6 depicts an exemplary predicting system where a behavioral model makes predictions based on contextual data, field of concern analysis and historical data, in accordance with one embodiment.

FIG. 7 depicts an exemplary process for performing risk assessment on VRU behaviors.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

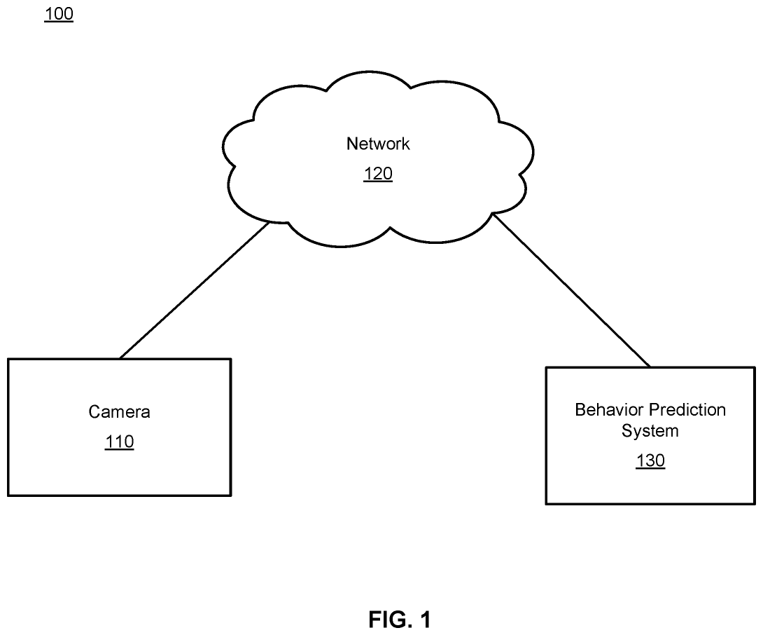

FIG. 1 depicts an exemplary system environment for a behavior prediction system, in accordance with one embodiment. Environment 100 includes camera 110, network 120, and micromobility risk prediction system 130. Camera 110 captures images or records video streams of VRUs and surroundings and transmits data via network 120 to behavior prediction system 130. Camera 110 is typically operably coupled to a vehicle, such as an autonomous or semi-autonomous vehicle. The vehicle may be an automobile (that is, any powered four-wheeled or two-wheeled vehicle). Camera 110 may be integrated into the vehicle, or may be a standalone (e.g., dedicated camera) or integrated device (e.g., client device such as a smartphone or dashcam mounted on vehicle). While only one camera 110 is depicted, any number of cameras may be operably coupled to the vehicle and may act independently (e.g., videos/images are processed without regard to one another) or in concert (e.g., videos/images may be captured in sync with one another and may be stitched together to capture wider views).

Network 120 may be any data network, such as the Internet. In some embodiments, network 120 may be a local data connection to camera 110. In one embodiment, network 120 provides the communication channels via which the other elements of the environment 100 communicate. The network 120 can include any combination of local area and/or wide area networks, using both wired and/or wireless communication systems. In one embodiment, the network 120 uses standard communications technologies and/or protocols. For example, the network 120 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

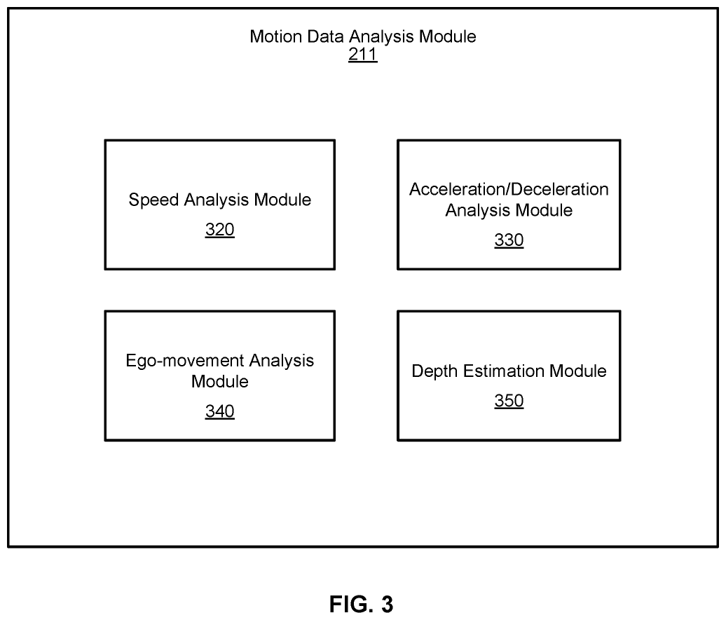

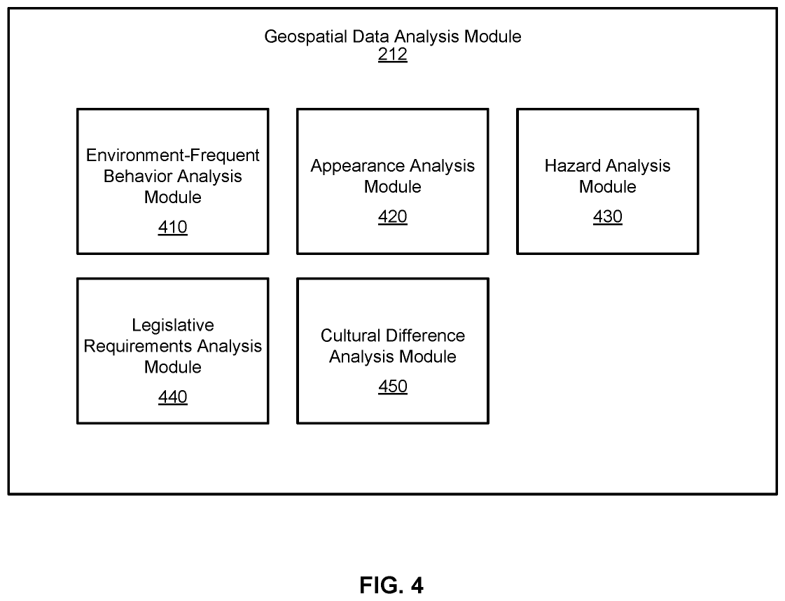

The behavior prediction system 130 predicts human behaviors based on environment-aware information such as camera movement data and geospatial data. The behavior prediction system 130 may analyze and understand contextual information associated with current location and situation based on received sensor data. The estimation of physics data, such as the distance and velocity towards and of other objects (vehicles, vulnerable road users, etc.) and tracking of objects relies heavily on camera movement. Additionally, tracking the objects in both 2-dimension images and 3-dimention environment can be improved by understanding the camera movement. For example, based on sensor data, the behavior prediction system 130 may determine camera movement information such as whether the camera is accelerating or decelerating, which may imply whether a driver of the vehicle is braking. Based on the speed of the vehicle, the behavior prediction model might allow for more or fewer uncertainty of behavior prediction. Contextual data analysis such as motion data analysis and geospatial data analysis is discussed in further detail below in accordance with FIGS. 3-4.

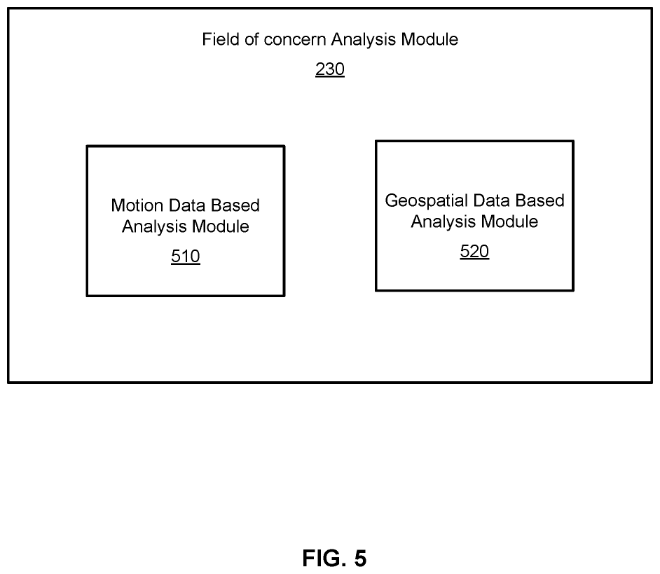

Additionally, the behavior prediction system 130 may also determine a field of concern in images of a video stream based on the sensor data and the images. The behavior prediction system 130 determines an adaptable area of interest such that more processing power may be assigned to the field of concern. Since the processing power is limited, focusing more processing power on a field of concern that is associated with a higher probability of risky behaviors may improve prediction accuracy and reduce the probability of occurrence of incidents. Field of concern analysis is discussed in further detail below in accordance with FIG. 5.

### Behavior Prediction System

The behavior prediction system 130 determines a probability that a vulnerable road user (VRU) will exhibit a behavior (e.g., continue on a current path (e.g., in connection with controlling an autonomous vehicle, become distracted, intend to cross a street, actually cross a street, become aware of a vehicle, and so on). In an embodiment, the behavior prediction system 130 receives an image depicting a vulnerable road user (VRU), such as an image taken from a camera of a vehicle on a road. The behavior prediction system 130 inputs at least a portion of the image into a model (e.g., a probabilistic graphical model or a machine learning model), and receives, as output from the model, a plurality of probabilities describing the VRU, each of the probabilities corresponding to a probability that the VRU is in a given state. The behavior prediction system 130 determines, based on at least some of the plurality of probabilities, a probability that the VRU will exhibit the behavior (e.g., continue on the current path), and outputs the probability that the VRU will exhibit the behavior to a control system. The disclosure of commonly owned patent application Ser. No. 16/857,645, filed on Apr. 24, 2020 and titled “Tracking Vulnerable Road Users Across Image Frames Using Fingerprints Obtained from Image Analysis,” which discloses more information with regard to a multi-task model with different branches each trained to form a prediction about a vulnerable road user (VRU), is hereby incorporated by reference herein in its entirety. Further information on combining different classifications into behavior prediction is discussed in the U.S. patent application Ser. No. 17/011,854, filed on Sep. 3, 2020, and titled “Modular Predictions for Complex Human Behaviors,” the disclosure of which is hereby incorporated by reference herein in its entirety.

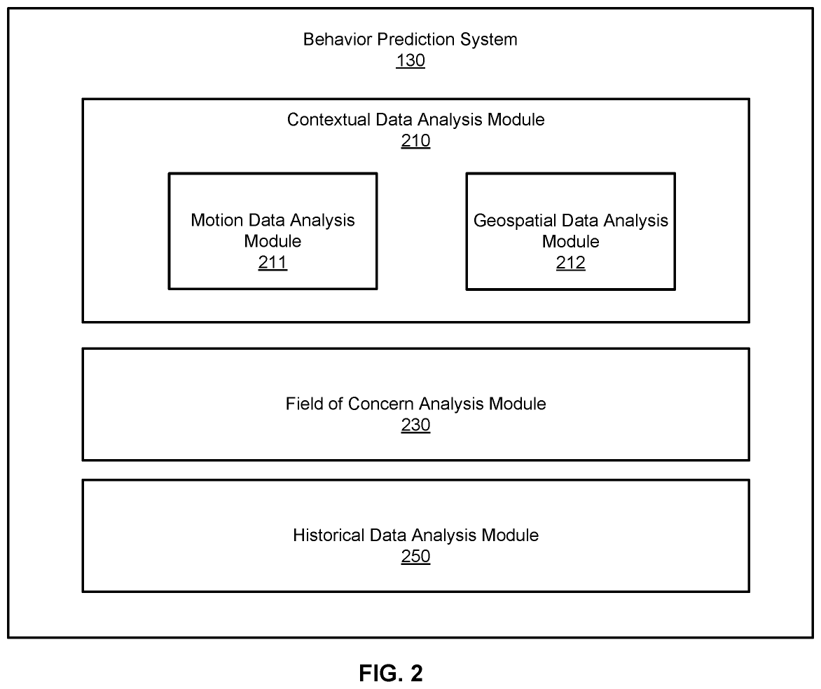

The behavior prediction system 130 may enrich the prediction model by analyzing sensor data and use contextual information as additional input to the prediction system 130. FIG. 2 depicts exemplary modules of a behavior prediction system 130, in accordance with one embodiment. The behavior prediction system 130 includes a contextual data analysis module 210 that analyzes and applies contextual data to the behavioral model, a motion data analysis module 211 that analyzes camera movement data, and a geospatial data analysis module 212 that focuses on analyzing time and location information associated with the environment in which a vehicle navigates. The behavior prediction system 130 may further include a field of concern analysis module 230 that determines a field of concern based on a set of sensor data and a historical data analysis module 250 that analyzes and applies historically observed data in the behavioral model.

Contextual data analysis module 210 analyzes and applies contextual data in the behavioral model. In one embodiment, contextual data analysis module 210 may include any information that is related to time, location, behavior distributions in a given environment, or state of the vehicle. Contextual data analysis module 210 as illustrated in FIG. 2 includes a motion data analysis module 211 and a geospatial data analysis module 212 which are discussed in further details below in accordance with FIGS. 3-4.

Field of concern analysis module 230 determines a field of concern for analysis and identifies one or more portions in the images associated with the field of concern. The field of concern may be one or more portions in images from a field of view, where the one or more portions of the images are associated with a higher likelihood of risky VRU behaviors. In one embodiment, the field of concern is determined by identifying certain objects or patterns from the images captured by the camera. In another embodiment, a field of concern is determined based on sensor data related to motion data or geospatial data associated with the camera. The field of concern analysis module may, based on detected objects/patterns and/or the other contextual information, determine that the field of concern may be associated with a higher likelihood than other portions of the images to be informative of risky behaviors. The field of concern analysis module 230 may assign more processing power to the determined field of concern than other portions of the image that are not in the field of concern. The field of concern may at times encompass the entire image (e.g., where the entirety of the image includes a high density VRUs). Further details with regard to the field of concern analysis module 230 is discussed in accordance with FIG. 5.

Historical data analysis module 250 performs analysis on historical data and use the historical data to update the behavior model for prediction of VRU behaviors. The historical data analysis module 250 may use previously collected historical data to alert, inform path planning, make predictions that specific behaviors may occur, generate responses to specific behaviors, optimized routing, driver education and more. The specific behaviors that the historical analysis module 250 predicts may be behaviors that are associated with potential risks. The historical data analysis module 250 may determine that the behavioral model needs to be updated to improve accuracy or efficiency for the specific situations when a type of behavior is observed more frequently during certain movement or geospatial location of the machine containing the camera, For example, if frequent risky interactions with other road users are observed while vehicles take a specific turn within a city, the historical analysis module 250 may optimize the route to avoid the turn, send alerts to drivers indicating that the turn is risky, send recommendations to a driver to recommend a lower speed, send alerts to personnel who are in a position to train the drivers, and so on. As another example, historical data analysis module 250 may generate and send instructions to autonomous vehicles to avoid the turns or take the turns more slowly.

In one embodiment, historical data analysis module 250 may use historical data for sending alerts or informing other parties. For example, the behavioral model may detect that an incident has occurred between the vehicle and another vulnerable road user, the historical data analysis module 250 may analyze the data and determine a likelihood of future incidents occurring that share similar attributes to those of the prior detected incidents. The historical data analysis module 250 may generate and send instructions to the vehicle such that the vehicle can automatically alert emergency services with the location of an incident and the likely severity of the incident based on the behavior of the vulnerable road user. Historical data analysis module 250 may also collect data and generate instructions for sending another post-incident alert to the insurance company, indicating the vehicle involved, the location of an incident, and/or an automatically drawn visualization generated from a dashcam of the traffic situation during the incident.

Historical analysis module 250 may also use a machine learning model that is trained using training data including historical incidents (e.g. information related to historical incident records available online) and use the historical incidents as prior information for future predictions using a Bayesian approach or taking a reinforcement learning approach. The data is captured from the fleet of devices running the models and alongside the predictions store the original sensor data. The machine leaning model may use training data from online, where the data is aggregated and labelled semi-automatically. For example, the training data may include sensor information such as vehicle status information (e.g. speed, whether the vehicle is making a turn, etc.), road condition, and the labels may be a binary label indicating whether an incident occurred. The labelled data may be further validated and used to update the behavior model or to train a new behavioral model.

FIG. 3 depicts an exemplary embodiment for modules of a motion data analysis module 211 of the behavior prediction system, in accordance with one embodiment. The motion data analysis module 211 includes a speed analysis module 320, an acceleration/deceleration analysis module 330, an ego-movement analysis module 340, and a depth estimation module 350. The motion data analysis module 211 analyzes sensor data and information related to camera movement, which are used to update the behavior prediction model. In one embodiment, motion information may include velocity (forward, angular) and rotation (roll, pitch, yaw) of the vehicle/camera. For example, motion data analysis module 211 may collect data from sensors such as IMU (Inertial Measurement Unit), speedometer, telematics systems, and the like to extract information related to movement of a camera operably coupled with a vehicle. Based on sensor data, information such as speed, acceleration, turning, yaw, rotating, etc. is extracted. The motion data analysis module 211 may use the motion information of the vehicle to separate vehicle motion from pedestrian motion to obtain more accurate estimates of pedestrian velocity.

Speed analysis module 320 may update the behavior prediction system 130 based on the speed of camera movement. For example, speed analysis module 320 may allow vehicles with higher speed for fewer uncertainty of behavior prediction compared with vehicle moving at a lower speed. Specifically, the speed analysis module 320 may determine a higher likelihood of risky behavior associated with a VRU if the camera is associated with a higher speed of movement. In one embodiment, the speed analysis module 320 may skip the other analysis (such as risk analysis based on pedestrian's gaze direction) in favor of a prompt risk detection (which may in turn translate to quicker remedial measures). For example, when a vehicle is travelling with 80 mph and a person is detected in the vehicle's projected path, speed analysis module 320 may determine that a higher risk of incident is associated with the vehicle instead of going through the process of analyzing the detected person's eye gaze or level of distraction. On the other hand, if the vehicle is traveling at 10 mph, the speed analysis module 320 may perform additional analysis that analyzes the pedestrian's eye gaze direction or whether the pedestrian is distracted before generating remedial instructions such as sending alerts to the driver.

Acceleration/deceleration analysis module 330 may update the behavior model based on the received sensor data indicating whether the vehicle is in acceleration or deceleration. Responsive to receiving information that the vehicle is decelerating, the acceleration/deceleration analysis module 330 may determine a higher risk associated with a pedestrian projected to pass the vehicle's path, and as a result the acceleration/deceleration module 330 may determine to send alerts to the driver. For example, the behavior prediction system 130 may detect that a pedestrian is moving towards the projected path of the vehicle. If the acceleration/deceleration analysis module 330 detects that the vehicle is decelerating, the acceleration/deceleration analysis module 330 may update the model to allow more risky behavior prediction and may not intervene with driving decisions as the deceleration may imply that the driver is already braking. On the other hand, if the acceleration/deceleration analysis module 330 detects that the vehicle is accelerating, then the acceleration/deceleration analysis module 330 may determine that the driver is distracted and has not yet noticed the pedestrian, and the prediction system may update the behavioral model to inform the vehicle system to intervene with driving (e.g. sending alert or executing automatic braking).

Ego-movement analysis module 340 may provide information for adjusting estimated location and movement of a VRU based on information associated with ego-movement. Ego-movement information may refer to information about current position and future projected trajectory of a device generated by the device's system (e.g. a route planned by a vehicle's navigation system or a robotic system). The ego-movement analysis module 340 may use ego-movement information to update the model for a more accurate risk assessment. In one embodiment, the ego-movement analysis module 340 may retrieve ego-movement information from a device coupled with the camera 110 (e.g. a vehicle system or robotic system). For example, a delivery robot that knows its own planned path may know that it will make a turn within 5 meters. As a result, the ego-movement analysis module 340 may provide the information to the behavior model and the prediction system may not perceive a person in its current path as at risk even though the person may be in its current path. As another example, a delivery robot that knows a delivery destination that is 10 meters away may not perceive a VRU that is 100 meters away as a risky factor.

Depth estimation module 350 estimates depth of monocular cameras based on movement information of the camera, and the depth estimation may be used to improve the behavior model estimation. A monocular camera is a type of vision sensor used in automated driving applications and one or more imaged captured by a monocular camera may be used for depth estimation (e.g. estimating a true distance away from an object in a 3-dimention (3D) environment based on one or more 2-dimension (2D) images). The depth estimation module 350 may use camera movement information for a more accurate depth estimation and when the depth estimation towards a person is of higher accuracy, the prediction accuracy of the person's movement may be improved, allowing the vehicle containing the camera to react earlier. The depth estimation module 350 may use the camera extrinsic information (e.g. a camera extrinsic matrix that describes the camera's location in a three dimensional world) for accurate distance estimation. The extrinsic information may include roll, pitch and yaw of the camera with respect to vehicle coordinates. For example, the depth estimation module 350 may compensate ego motion of the camera such as velocity and rotation of the vehicle for accurate prediction. In one embodiment, the depth estimation module may compensate the ego motion within a Kalman filter, where a Kalman filter may be used to predict the next set of actions associated with other cars/pedestrians based on the data that are currently available to the prediction system. The Kalman filter may track the ego motion as a state space variable (e.g. a variable whose values evolve over time in a way that depends on the values for previous states) and is aperiodically or periodically (e.g. every 30 seconds) updated every frame using the measurements from the motion sensor data. Therefore, depth estimation module 350 may derive depth estimation based on sensor data which can provide more information about the vehicle's ego movement and may yield a more accurate estimation of depth, which may lead to a more accurate prediction of human behaviors.

FIG. 4 depicts an exemplary modules of a geospatial data analysis module 212 of the behavior prediction system, in accordance with one embodiment. Geospatial data analysis module 212 analyzes data related to time and location associated with the surroundings of a machine (e.g. a vehicle). In one embodiment, geospatial data analysis module 212 includes an environment-frequent behavior analysis module 410, an appearance analysis module 420, a hazard analysis module 430, a legislative requirements analysis module 440, and a cultural difference analysis module 450. Further details of the modules in the geospatial data analysis module 212 are discussed below.

Environment frequent behavior analysis module 410 analyzes behaviors frequent to a specific environment. As a camera enters an environment, the environment frequent behavior analysis module 410 may update the types of behaviors that frequently occur or are especially relevant in the environment. The environment frequent behavior analysis module 410 may use a trained machine learning model for identifying a specific environment based on video stream/images. Based on the identified specific environment, the environment frequent behavior analysis module 410 may associate a set of behaviors that are frequently seen in the environment by using a trained machine learning model. The environment frequent behavior analysis module 410 may determine to adjust the risk perception level associated with the VRUs observed in the environment based on the environment-frequent behaviors. In one embodiment, the trained machine learning model may be trained using a set of training data of video stream/input images including individuals posing certain postures or behaviors. The machine learning model may be trained to associate the identified postures or behaviors with the identified environment and the parameters are saved for future predictions. The environment frequent behavior analysis module 410 may determine a lower level of behavioral risk associated with the behaviors that are known to associated with an identified environment.

For example, as a delivery vehicle enters a port, the environment frequent behavior analysis module 410 may first recognize that the environment is a port. The environment frequent behavior analysis module 410 may further associate the port with a set of behaviors that are frequently observed in a port. The environment frequent behavior analysis module 410 may also be trained to recognize behaviors based on images or video stream. As a concrete example, the environment frequent behavior analysis module 410 may detect and recognize specific gestures related to standard port vehicle instructions by marshals, and determine that the detection of such behaviors is not associated with a high level of risk (while such behaviors observed on a road highway may indicate a higher risk level). Further information on determining intent of a human based on human pose is discussed in details in the U.S. patent application Ser. No. 16/219,566, titled “Systems and Methods for Predicting Pedestrian Intent,” filed on Dec. 13, 2018, the disclosure of which is hereby incorporated by reference herein in its entirety.

Appearance analysis module 420 analyzes appearance information of individuals and assess risk profile by classifying people based on appearance. The appearance analysis module 420 may generate a risk profile based on features extracted from appearances to derive information such as the type of the work they perform. The appearance analysis module 420 may identify, using a machine learning model, the environment from the images/video stream, and based on the identified environment, the appearance analysis module 420 may retrieve from a database, requirements of clothing or other visual differentiations associated with the identified environment (such as a safety hat in required in a factory or protective biohazard suit in a laboratory). For example, certain environments may require the recognition of behaviors specifically exerted by unique classes of people, which can be indicated by the individual wearing specific clothing, or other visual differentiators. For example, appearance analysis module 420 may identify when a factory worker is not wearing a safety hat, and the appearance analysis module 420 may determine that the worker is associated with a higher likelihood of being involved in an incident. The appearance analysis module 420 may update the behavior prediction model and the behavior prediction system 130 may generate an alert to the worker or to the construction site operator based on the risk assessment.

Hazard analysis module 430 may determine event data and/or land use data that may inform behavioral risk. The term event, as used herein, may refer to a planned public event or occasion with time and/or location information. The term land use data, as used herein, may refer to either regulations on land use, or attributes thereof. For example, land use data may indicate a type of person frequently on the land (e.g., children in school areas); times of day where risk may be heightened (e.g., school hours; park hours where park is closed overnight), etc. The hazard analysis module 430 may use the determined event data and/or land use data to determine a level of risk perception because the event and/or land use data may inform information such as what type of person is going to be around, in at what volume, and with what level of attention.

As an example, the hazard analysis module 430 may update the behavior prediction system 130 by updating hazard perception logic based on different geographical areas. For example, the hazard analysis module 430 may determine from sensor data (e.g. GPS data or from image recognition) that a commercial vehicle is driving through a school area. The hazard analysis module 430 may determine a higher likelihood of risk associated with VRUs observed in the school area. The hazards analysis module 430 may determine that the alert logic of a blind spot monitoring system might need to be extra sensitive (e.g. more processing power is assigned to the blind spot monitoring system when driving) when a commercial vehicle is driving through a school area with many children.

In one embodiment hazard analysis module 430 may model the behaviors of different regions of the city, based on land use type of region (e.g. residential, commercial, industrial etc.), as well as the types of establishments in the area (e.g. bars, stadiums). The hazard analysis module 430 may also predict information such as how crowded the different areas are at different times of the day. In one embodiment, the hazard analysis module 430 may retrieve information associated with specific events (such as a football match, or a concert) that may trigger specific types of behaviors that would otherwise not be seen in the area. The hazard analysis module 430 may retrieve such information from the internet (e.g. concert/sports bookings, shops from Google Maps, land use type from open street map) and use the information as inputs that go into the determination of risk of pedestrians. The hazard analysis module 430 may use such information and update the prediction model such that the model can adapt to situations in cities by using the information as inputs for the risk perception in order to have fewer false positive predictions in new situations.

Legislative requirements analysis module 440 may determine legislative requirements that may inform behavioral risk. As used herein, the term “legislative requirements” may refer to legislative requirements such as laws, regulations, acts, orders, by-laws, decrees, or the like. Legislative requirements may further include permits, approvals, licenses, certificates, and other directives made by any other authorities. Different legislative requirements in different geographical locations may inform different behavioral risks. The legislative requirements analysis module 440 may update the behavior prediction system 130 to associate behaviors with different risk levels based on the different legislative requirements for different geographical locations, such as different countries that the camera enters, smaller areas within a country that have different laws, different types of roads that a vehicle containing the camera might drive on, construction sites, logistics, transportation, etc. In one embodiment, the legislative requirements are manually inputted. The legislative requirements analysis module 440 may retrieve a set of legislative requirements, based on a geographical location (e.g. a country) determined based on sensor data. The legislative requirements analysis module 440 may further based on the set of legislative rules, assign different risk levels to certain behaviors. For example, different factories may enforce different rules inside the factories based on legislative requirements enforced by the law unique to the area, and the legislative requirement analysis module 440 may enable the behavior prediction system 130 to take the location (e.g. different countries or cities) as an input parameter, and the behavior prediction system 130 may access behavioral risk based on the corresponding legislative requirements in making predictions. As a concrete example, different countries may have different legislative requirements with regard to a distance between a machine such as an autonomous lifting fork and humans. A rule in a Belgian factory may require 20 meters between the machine and humans while a rule in the U.S. may require a 15-meter safety distance. The legislative requirement analysis module 440 may determine a higher level of risk if a human is detected to be 17 meters away from a machine in a Belgian factory, while a lower level of risk may be determined if a human is detected to be the same distance away from a machine in a factory in the U.S.

Cultural difference analysis module 450 may determine behaviors associated with different cultures that inform behavioral risks. The term “cultural difference” as used herein, may refer to a range of behaviors affected by socially acquired values, beliefs, and rules of conduct which make the behaviors distinguishable from one societal group to another. The cultural difference analysis module 450 further updates the behavior prediction system 130 based on different behaviors customly observed in different cultures. As a same behavior may be interpreted differently in different cultures, the cultural difference analysis module 450 may further update the model and access risky behaviors based on prior knowledge of cultural differences. In one embodiment, the behavior patterns associated with different cultures are manually inputted, while in another embodiment, the behavior pattern may be identified by a machine learning algorithm that is trained to classify different behavior patterns given different geographical locations. For example, in some countries it is generally accepted by society that a person walks along the curb prior to crossing the street, whereas in other countries such behavior would be seen as extremely risky behavior. The cultural difference analysis module 450 may take country or location as an input parameter and update the prediction model based on the trained model's learned knowledge about behavior pattern of the geographic location. As a more concrete example, based on GPS data, the cultural difference analysis module 450 may determine that a vehicle is navigating in a country where it is generally accepted by the society for pedestrians to walk in the bike lane of the road. Then the cultural difference analysis module 450 may determine a lower probability for viewing a pedestrian walking in a bike lane as a risky behavior.

FIG. 5 depicts an exemplary embodiment of a field of concern analysis module 230, in accordance with one embodiment. A field of concern may be determined based on various inputs such as contextual information including camera movement data and geospatial data. As illustrated in FIG. 5, the field of concern analysis module 230 includes a motion data based analysis module 510 that determines a field of concern based on camera movement data, and a geospatial data based analysis module 520 that determines a field of concern based on geospatial data. The motion data based analysis module 510 and the geospatial data based analysis module 520 are discussed in further details below.

The motion data based analysis module 230 may determine to assign a higher level of processing power to certain areas within the field of view based on the movement of the camera. The motion data based analysis module 230 may use a trained machine learning model to determine a field of concern based on movement data received from the sensors. In one embodiment, the trained machine learning model may be trained with a set of training data with video stream/images with labeled areas for a field of concern. The labels may indicate a level of risk perception associated with the areas, or alternatively, the labels may be binary indicators indicating whether the areas are associated with incidents that occurred previously. In another embodiment, the trained machine learning model may be trained with video stream/images and an indication of where historical incidents previously occurred, and the machine learning model may be trained to identify areas with similar features as the areas with historical incidents. The motion data based analysis module 230 may determine a field of concern using the trained machine learning model, which may take a video stream/images and motion data as input and determine one or more portions of the images for assigning more processing power. For example, for a vehicle containing a camera that is traveling at higher speed, it is more advantageous to assign processing power to a narrow field of view in front of the vehicle, because subjects (people, cars, other objects in the environment) are more likely to end up in the path of the vehicle if the objects were to be involved in an incident with the vehicle. Similarly, when the motion data based analysis module 230 detects from sensor data that the driver is turning the vehicle to the right, the motion data based analysis module 230 may determine a higher likelihood that an incident to occur in the right direction (e.g. on the right side) of the vehicle, and therefore the field of concern analysis module 230 may focus the field of view on the right side of the vehicle.

The geospatial data based analysis module 520 may determine to assign a higher level of processing power to certain areas within the field of view based on the geographic environment of the camera. The geospatial data based analysis module 520 may use a trained machine learning model to determine a field of concern that may benefit from having extra processing power to process in a more robust or faster manner. In one embodiment, the geospatial data based analysis module 520 may determine a field of concern based on behavior pattern associated with the VRUs based on a type of a geographical location, such as city or rural area, residential or commercial area. The machine learning model may be trained with training data such as labeled images/videos of various types of locations and the geospatial data based analysis module 520 may use the machine learning model to determine that certain areas within a frame may require additional processing power. For example, when a delivery robot enters an area within a city that is generally very crowded, the field of concern analysis module 230 may determine a field of concern that focuses on the lower part of people's bodies and limit processing power to detecting the lower part of people's bodies, such that the behavior prediction model may track more people simultaneously and may be helpful in avoiding collision. The prediction model configuration may be tuned and updated by taking into account additional behavioral features (such as focusing on people's lower bodies in a crowded city.) The prediction model may be trained to update model weights based on the updated model configuration to make predictions based on the behavioral features.

The geospatial data based analysis module 520 may further determine a field of concern based on rules that suggest certain behavior pattern associated with a location. For example, certain legislative requirements may imply that certain VRU behaviors associated with a type of the VRU may require additional processing power to pay extra attention to the type of the VRU. As a concrete example, a vehicle may enter a cyclestreet, which is a street that is designed as a bicycle route, but on which cars are also allowed. A cyclestreet may imply that bicycles are the primary users of the street, while the motor vehicles are secondary. For example, vehicles may be prohibited from overtaking cyclists on a cyclestreet and a cyclestreet may also have a speed limit (e.g., 30 km/h) for motor vehicles. For a vehicle navigating in a cyclestreet, the geospatial data based analysis module 520 may apply more processing power to cyclists and behavioral models associated with cyclists (relative to the processing power that would be applied on a more typical street that is not a cyclestreet), because vehicles may need to be more cautious to cyclists in a cyclestreet than usual. Additionally, the geospatial data based analysis module 520 may determine additional behavioral features to be detected based on geospatial data and therefore assigning more processing power to process the additional features. For example, for a delivery robot entering someone's lawn to deliver a package, the geospatial data based analysis module 520 may determine to assign more processing power to enable a facial feature model for identification and emotion recognition, which may not be enabled for regular sidewalk navigation due to intensive processing power consumption.

In one embodiment, the field of concern analysis module 520 may determine a field of concern based on inputted images using computer vision models. For example, the field of concern analysis module 230 may identify objects of interest in images in a video stream, such as street signs and school zones. Presence of such objects of interest may imply a higher risk of incident occurring in such areas. In one embodiment, the field of concern analysis module 520 may use a trained machine learning classifier for object recognition that identifies the objects of interest in the images. The trained machine learning classifier may also be trained to associate the identified objects with a risk level based on historical data or based on a predetermined map table that maps certain objects to a risk level. In one embodiment, the field of concern analysis module 230 may determine a field of concern that includes the portions of images including such objects of interest. In yet another embodiment, the field of concern analysis module 230 may determine the field of concern using pixel-based approaches. For example, the field of concern analysis module 230 may estimate the vanishing point based on inputted images in the video stream and may use optical flow to extract the movement of the vehicle.

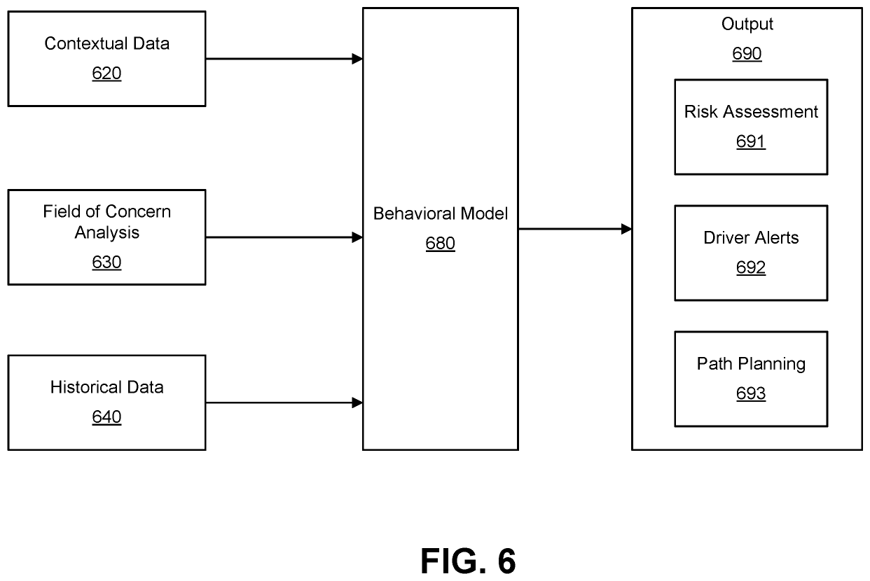

FIG. 6 illustrates one exemplary process for updating the behavioral model 680 based on contextual data 620, field of concern analysis 630, and historical data 640. In one embodiment, the behavioral model 680 may be updated by contextual data 620, field of concern analysis 630, and historical data 640 through various methods, such as using simple logic (e.g. pre-determined rules and algorithms), using learned logic to update the models (e.g. machine learning models), or using probabilistic methods to update the models (e.g. Bayesian models).

In one embodiment, contextual data 620 such as motion information and geographic information may be factors or input variables to the behavioral model 680. The behavioral model 680 may be updated through different weightings of different underlying models, updating the weights of the underlying models, or adding/removing underlying models. More details with regard to predicting VRU behaviors with a plurality of underlying models each corresponding to a state of the VRU are discussed in the U.S. patent application Ser. No. 17/011,854, titled “Modular Predictions for Complex Human Behaviors,” filed on Sep. 3, 2020, the disclosure of which is hereby incorporated by reference herein in its entirety.

The behavioral model 680 may be trained with context-specific data using supervised or unsupervised learning. The behavioral model 680, instead of using only data from a specific context (e.g., from London) for the development of a particular model, may use data from a variety of contexts (e.g., Tokyo, Dubai, London) and include the type of city as a factor in the behavioral model 680. The model may be trained with data from a variety of geographical locations but the presence of a specific geographical location (e.g. a specific city) may affect certain parameters of the model. The behavioral model 680 may adjust parameters based on any geographical information that can be extracted such as information from GPS, map, online, or through computer vision models. As an example, the behavioral model 680 may include a sub-model for accessing “risk perception”, which includes a binary factor of whether the presence of a type of road infrastructure, such as a crosswalk is identified in image or based on geospatial data. A road infrastructure, as used herein, may refer to all physical assets within the road reserve, including not only the road itself, but also associated signage, signs, crosswalks, earthworks, drainage, structures (culverts, bridges, buildings etc.) The behavioral model 680 may be trained to adjust parameters of the model “risk perception” based on the presence of a crosswalk (e.g. or other street signs such as street signs for animal crossing). Specifically, the behavioral model 680 may be trained to generate a lower level of risk perception when a pedestrian is standing at a crosswalk for a vehicle with the same speed and acceleration. When the pedestrian is standing at an intersection without a crosswalk, the risk perception associated with the pedestrian may be higher because the driver of the vehicle may be less alerted when traveling across the intersection. In the example, the presence of a crosswalk is considered as a factor in the model that automatically adjusts the parameters of the behavioral prediction model 680. Contextual data 620 such as the information discussed in FIG. 3 may be similarly trained as context-specific parameters that adjust the behavioral model 680.

Similarly, motion information about vehicle/camera behavior may serve as input variables to sub-models of the behavioral model 680. For example, vehicle velocity, acceleration, and distance may be used to determine the situation criticality where situation criticality may be a sub-model of the behavioral model 680. The situation criticality may be combined with motion data to provide risk perception. The behavioral model 680 may generate different predictions if motion parameters such as velocity, acceleration or yaw of the vehicle change. As a more specific example, the behavioral model 680 may decrease the pedestrian's risk perception of crossing the vehicle lane responsive to determining that the vehicle is decelerating. In one embodiment, the parameters may be included as a feature in a machine learning model, and the parameter weightings can be trained and optimized based on data. Alternatively, the factors may be incorporated in a multilevel (e.g. hierarchical) model such as a Bayesian model, where the context is on a level that is above the variables of the prediction model, and therefore the context-specific attributes affect the model variables simultaneously.

In one embodiment, the behavioral model 680 may be trained to optimize the weightings associated with the variety of parameters to achieve more accurate predictions. The behavioral model 680 may be trained to adjust the weightings depending on whether each parameter increases or decreases prediction performance based on statistical analysis of accident data or logic based on behavioral studies and ethical considerations. That velocity can be a parameter of a behavioral model, and therefore may increase the accuracy of the higher level model. The behavioral model 680 may store the trained weightings and models within the vehicle's memory or in a cloud where the weightings may be updated over-the-air periodically and downloaded by the vehicle. The trained behavioral model 680 may generate various types of outputs 690 including but not limited to generating risk assessment 691 for the VRUs given different context-specific attributes, sending alerts 692 to drivers (e.g. warning of a risky maneuver or a crossing pedestrian), and planning paths based on risk assessment 693 (e.g. avoiding certain areas based on event information available online or based on the prior knowledge that a school zone is associated with a higher risk at a given time).

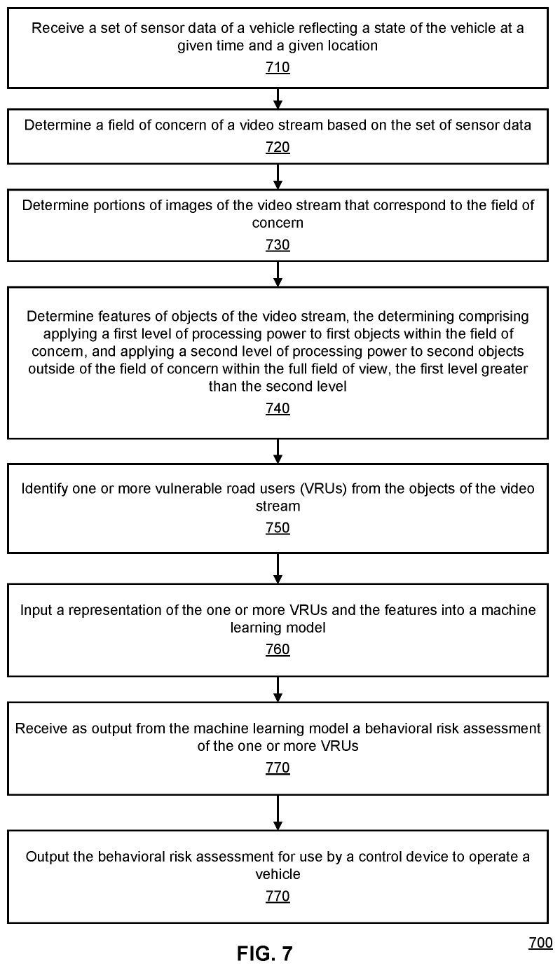

FIG. 7 illustrates an exemplary process of generating a behavioral risk assessment by determining a field of concern based on a set of received sensor data. Process 700 starts with the behavior prediction system 130 receiving 710 a set of sensor data of a vehicle reflecting a state of the vehicle at a given time and a given location. The field of concern analysis module 230 may determine 720 a field of concern of a video stream based on the set of sensor data. Based on the field of concern, portions of images of the video stream may be determined 730 for feature extraction. The behavior prediction model 130 may determine features of objects of the video stream, the determining comprising applying a first level of processing power to first objects within the field of concern, and applying a second level of processing power to second objects outside of the field of concern within the full field of view, the first level greater than the second level. The behavior prediction model may then identify 750 one or more vulnerable road users from the objects of the video stream and input a representation of the one or more VRUs and the features into a machine learning model. The behavior prediction system 130 may receive as output from the machine learning model a behavioral risk assessment of the one or more VRUs and output 770 the behavioral risk assessment for use by a control device to operate a device.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a set of sensor data of a vehicle reflecting a state of the vehicle at a given time and a given location;
determining, based on the set of sensor data, a field of concern of a video stream;
determining, from the video stream received from a camera that is operably coupled to the vehicle, one or more portions of images of the video stream that correspond to the field of concern, the field of concern smaller than a full field of view of the images;
determining features of objects of the video stream, the determining comprising applying a first level of processing power to first objects within the field of concern, and applying a second level of processing power to second objects outside of the field of concern within the full field of view, the first level greater than the second level;
identifying one or more vulnerable road users (VRUs) from the objects of the video stream;
inputting a representation of the one or more VRUs and the features into a machine learning model;
receiving as output from the machine learning model a behavioral risk assessment of the one or more VRUs; and
outputting the behavioral risk assessment for use by a control device to operate a vehicle.

2. The method of claim 1, further comprising:
determining context-specific attributes associated with one or more of the given time and the given location, wherein the context-specific attributes are input along with the representation into the machine learning model.

3. The method of claim 2, wherein the determination of context-specific attributes comprises:
retrieving event data from a database, the event data extracted from one or more websites that include at least a time and location associated with an event,
wherein determining the context-specific attributes is based on the retrieved data.

4. The method of claim 2, wherein the determination of context-specific attributes is further based on a land use type of the given location or a type of establishments associated with the given location.

5. The method of claim 1, wherein determining the features of the objects further comprises:
identifying one or more of street signs in the video stream, and wherein the determination of features is further based on the identified one or more street signs, the features indicating a behavior pattern associated with VRUs at the given location at the given time.

6. The method of claim 1, further comprises:
determining, based on the set of sensor data, camera movement information associated with the camera, wherein the camera movement information comprises data including speed, acceleration, or yaw.

7. The method of claim 6, further comprises:
estimating a depth of an image of the images based on camera movement information; and
determining a distance from an object in the image based on the depth estimation.

8. The method of claim 1, further comprises:
retrieving historical data associated with the given location, the historical data indicating incidents that previously occurred at the given location at the given time;
retraining the machine learning model with the historical data, wherein the retrained machine learning model is retrained to predict a likelihood of a specific behavior at the given location at the given time.

9. The method of claim 1, wherein the determination of features is based on a legislative requirement or a cultural difference specific to the given location, the legislative requirement or cultural difference indicating a pattern associated with the behaviors of VRUs at the given location.

10. The method of claim 1, wherein determining the features of the objects further comprises:
identifying a type of road infrastructure in the video stream, and wherein the determination of features is further based on the identified type of road infrastructure, the features indicating a behavior pattern associated with VRUs at the given location at the given time.

11. The method of claim 1, further comprising:
determining, based on the set of sensor data, that a type of VRU in the video stream is to be allocated additional processing power relative to other types of VRUs;
identifying a group of VRUs from the identified one or more VRUs having the determined type of VRU; and
applying a third level of processing power that is greater than the first and the second level of processing power to the group of identified VRUs.

12. The method of claim 1, further comprising one or more of:
tuning a model configuration of the machine learning model to take into account additional behavioral features that are determined based on the set of sensor data; and
updating weights of the machine learning model based on the tuned model configuration.

13. A non-transitory computer-readable storage medium storing executable computer instructions that, when executed by one or more processors to perform steps comprising:
receiving a set of sensor data of a vehicle reflecting a state of the vehicle at a given time and a given location;
determining, based on the set of sensor data, a field of concern of a video stream;
determining, from the video stream received from a camera that is operably coupled to the vehicle, one or more portions of images of the video stream that correspond to the field of concern, the field of concern smaller than a full field of view of the images;
determining features of objects of the video stream, the determining comprising applying a first level of processing power to first objects within the field of concern, and applying a second level of processing power to second objects outside of the field of concern within the full field of view, the first level greater than the second level;
identifying one or more vulnerable road users (VRUs) from the objects of the video stream;
inputting a representation of the one or more VRUs and the features into a machine learning model;
receiving as output from the machine learning model a behavioral risk assessment of the one or more VRUs; and
outputting the behavioral risk assessment for use by a control device to operate a vehicle.

14. The non-transitory computer-readable storage medium of claim 11, wherein the steps further comprise:
determining context-specific attributes associated with one or more of the given time and the given location, wherein the context-specific attributes are input along with the representation into the machine learning model.

15. The non-transitory computer-readable storage medium of claim 12, wherein the determination of context-specific attributes comprises:
retrieving event data from a database, the event data extracted from one or more websites that include at least a time and location associated with an event,
wherein determining the context-specific attributes is based on the retrieved data.

16. The non-transitory computer-readable storage medium of claim 11, wherein determining the features of the objects further comprises:
identifying one or more of street signs in the video stream, and wherein the determination of features is further based on the identified one or more street signs, the features indicating a behavior pattern associated with VRUs at the given location at the given time.

17. The non-transitory computer-readable storage medium of claim 11, further comprises:
determining, based on the set of sensor data, camera movement information associated with the camera, wherein the camera movement information comprises data including speed, acceleration, or yaw.

18. The non-transitory computer-readable storage medium of claim 11, further comprises:
retrieving historical data associated with the given location, the historical data indicating incidents that previously occurred at the given location at the given time;
retraining the machine learning model with the historical data, wherein the retrained machine learning model is retrained to predict a likelihood of a specific behavior at the given location at the given time.

19. The non-transitory computer-readable storage medium of claim 11, wherein the determination of features is based on a legislative requirement or a cultural difference specific to the given location, the legislative requirement or cultural difference indicating a pattern associated with the behaviors of VRUs at the given location.

20. The non-transitory computer-readable storage medium of claim 11, wherein determining the features of the objects further comprises:
identifying a type of road infrastructure in the video stream, and wherein the determination of features is further based on the identified type of road infrastructure, the features indicating a behavior pattern associated with VRUs at the given location at the given time.
